(19) United States
(12) Patent Application Publication
(10) Pub. No.: US 2004/0205032 A1
(43) Pub. Date: Oct. 14, 2004

(54) Hydrogen/electric energy distribution system

(76) Inventors: Michael Routtenberg, Vancouver (CA); Walter Roberto, Victoria (CA)

Correspondence Address: Edward W. Bulchis, Esq., DORSEY & WHITNEY LLP, Suite 3400, 1420 Fifth Avenue, Seattle, WA, 98101, US

(21) Appl. No.: 10/833,551

(22) Filed: Apr. 27, 2004

Related U.S. Application Data
(63) Continuation of application No. 09/492,934, filed on Jan. 27, 2000.
(60) Provisional application No. 60/159,023, filed on Oct. 12, 1999.

(51) Int. Cl. G06F 17/00; H01M 8/00

(52) U.S. Cl. 705/400; 429/13

(57) ABSTRACT

An energy delivery system for regenerative fuel cell vehicles includes a plurality of geographically distributed stations (100). Each station includes an external port 109 that supplies the chemical constituents for manufacturing hydrogen fuel on-board a vehicle. Specifically, the port provides water from a municipal water supply (124) and an electricity connection to the electrical transmission and distribution grid (122) and the building's local electrical distribution system (114). Additionally, the port provides for the transmission of data from the vehicle over the Internet to the electrical service providers that sell electrical power to retail customers over the distribution grid. Supply of power, and the flow of data, through the external port is automatically controlled via a port controller. Each regenerative fuel cell vehicle is provided with a corresponding internal port (105) that supplies water and electricity, received from the external port through a connecting cable (107), to an on-board electrolytic hydrogen fuel production plant (120). An on-board energy management computer (624) controls the purchase of electricity by the vehicle from the station, the particulars of which may be negotiated over the Internet by the external port controller (103) and/or the internal on-board energy management computer. Additionally, the vehicle can generate electricity from internally stored hydrogen, for delivery to the building's local electrical distribution system via the external station. The on-board energy management computer (624) controls the sale of electricity by the vehicle to the station, the particulars of which may be negotiated over the Internet by the external port controller (103) and/or the internal on-board energy management computer.

### CROSS REFERENCE TO RELATED APPLICATION

The present application claims the benefit of the filing date of U.S. Provisional Patent Application Serial No. 60/159,023 filed Oct. 12, 1999.

### FIELD OF THE INVENTION

The field of the invention concerns a method for the delivery of energy (particularly, energy derived via sustainable means) between external electricity networks and hydrogen fuel cell electric vehicles and other portable hydrogen fuel cell electric devices and to a system for automatically managing the multi-party financial transactions associated with such energy delivery.

### BACKGROUND OF THE INVENTION

### a. The Need For Alternate Transportation Technologies

Fossil fuel combustion has been chiefly responsible for several adverse environmental impacts: first poor local air quality, then regional acidification and, finally, global increases in atmospheric concentration of greenhouse gases (GHG). GHGs remain in the earth's atmosphere for several hundred years, and their increased concentrations can cause global climatic disruption. Since fossil fuel combustion correlates closely with economic and population growth, current energy usage patterns, if continued, will lead to geometric increases in emissions of GHGs.

Another problem concerning fossil fuels is related to the inequitable distribution of global petroleum resources. This results in energy dependency, which forces most industrial countries to import growing quantities of oil in order to meet the domestic demand for petroleum derived fuels such as gasoline, diesel and Jet-A. In 1997, the Unites States imported 8.95 million barrels per day (MBPD) of crude oil and petroleum products, compared with only about 2 MBPD in 1967. US Transportation Statistics Annual Report, p. 110 (1998).

The energy derived from petroleum fuels is principally used in heating, industrial production, electricity generation and transportation. However, transportation is the largest consumer of these fuels, and it is increasing its consumption faster than any other economic sector. In 1998, transportation accounted for almost two-thirds (US Dept. of Energy, Energy Information Administration, Annual Energy Review 1996, DOE/EIA-0384(96) (Washington, D.C.: 1997)) of the 120 billion gallons of gasoline and 27 billion gallons of diesel fuel (US Dept. of Energy, Energy Information Administration, Annual Energy Review 1996, DOE/EIA-0384(96) (Washington, D.C.: 1997)) consumed in the United States.

The transportation sector's large consumption of petroleum based fuels coupled with growing concern over the environmental and geopolitical consequences of heavy oil use, are major driving forces propelling the development of new transportation technologies. Certain technologies aim to coexist with current transportation technologies, while others seek to replace them entirely.

b. Competing New Transportation Technologies

The automotive industry, in its Partnership for a New Generation of Vehicles, has developed hybrid diesel/electric and gasoline/electric automobiles that achieve 60 to 80 miles per gallon, thereby reducing overall emissions by utilizing less fuel than conventional internal combustion engine vehicles.

The automotive and oil industries together are developing a technology termed “clean diesel”. This technology employs new fuels and catalytic converters that work hand in hand to reduce nitrous oxides, sulfur oxides, carbon monoxide and particulate matter emissions associated with the operation of gasoline and diesel engines, by as much as 90%.

Battery powered electric vehicles (BPEVs) have, for many years, been proposed as an alternative to the internal combustion engine. Indeed, BPEVs were introduced in the early 1900s but have had a negligible impact in the consumer marketplace. In recent years, most of the large automobile manufacturers have introduced electric vehicles, such as the General Motors EV1™, the Ford RANGER™ EV pickup and the Chrysler EPIC™ EV minivan. However, despite recent advances in lighter structural materials, BPEVs still suffer from weight limitations and poor performance. A primary barrier to the widespread use of these vehicles is related to the low volumetric and gravimetric energy densities found in secondary (rechargeable) batteries. Low energy densities translate into short ranges between recharging and limit the use of BPEVs to light-duty applications. The typical range of BPEVs is between 75 and 130 miles. In addition, batteries must be replaced every few years and this implies the need for recycling or disposal schemes.

### c. Fuel Cell Technologies

Fuel cell technologies hold the promise of at last making electric vehicles practical by eliminating the problems associated with batteries. Unlike a battery, a fuel cell does not store energy and does not consume itself to generate electricity. Instead, it converts externally supplied chemical fuel and oxidant to electricity and reaction products. In electrochemical fuel cells employing hydrogen as the fuel and oxygen as the oxidant, the only reaction products are water and heat. Furthermore, 40% to 60% of the fuel's available chemical energy is converted directly to useful electrical energy.

There are five different types of fuel cell technologies that can be used for power generation in stationary and mobile applications. The details and operation characteristics of each of these technologies have been extensively reviewed. A. J Appleby and FR. Foulkes, Fuel Cell Handbook, Krieger Publishing Company, Malabar, Fla., USA (1993). Out of the five categories, Proton Exchange Membrane Fuel Cells (“PEMFCs”) have been identified as the most appropriate technology for vehicular applications, and are thus preferred for use in the present invention.

Conventional PEMFCs generally employ a layered structure known as a membrane electrode assembly, comprising an ionic conductor, which is neither electrically conductive nor porous, disposed between an anode electrode layer and a cathode electrode layer. The electrode layers are typically comprised of porous, electrically conductive sheets with electro-catalyst particles at each membrane-electrode interface to promote the desired electrochemical reaction.

During operation of the fuel cell, hydrogen from a fuel gas stream moves from fuel channels through the porous anode electrode material and is oxidized at the anode electro-catalyst to yield electrons to the anode plate and hydrogen ions, which migrate through the ionic conductor. At the same time, oxygen from an oxygen-containing gas stream moves from oxidant channels through the porous electrode material to combine with the hydrogen ions that have migrated through the electrolyte membrane and electrons from the cathode plate to form water. A useful current of electrons travels from the anode plate through an external circuit to the cathode plate to provide electrons for the reaction occurring at the cathode electro-catalyst. This current can be conditioned and subsequently used to power electrical devices such as a motor.

The PEM fuel cell, by virtue of its ability to conveniently and efficiently convert hydrogen into electricity, allows hydrogen, rather than batteries, to become a storage medium for electricity. Even with today's pressure bottle hydrogen storage technology, hydrogen powered fuel cell electric vehicles (“FCVs)” have the potential to achieve a range of more than 300 miles between refueling stops. According to the US Dept. of Energy, electric vehicles become practical in consumer markets upon achieving a threshold range of 310 miles between refueling stops. Most importantly, FCVs emit only water vapor as a by-product of their operation.

Most industry experts agree that FCVs provide the long-term solution to the environmental and geopolitical problems associated with fossil fuels. FCVs solve the environmental problems by eliminating all harmful emissions and answer geopolitical concerns because hydrogen does not depend on fossil fuels for its production. The nature and timing of the transition to FCVs, however, remains unclear primarily because of uncertainties over how to create the necessary supporting hydrogen fuel infrastructure. There are several approaches proposed for solving this infrastructure problem.

d. On Board Reformation of Conventional Fuels

The first approach is a transition approach. It is based on the notion that there is no economic incentive to develop a direct hydrogen-refueling infrastructure until FCVs achieve some threshold of consumer penetration. Since consumers, on the other hand, have no incentive to acquire FCVs unless they can conveniently refuel them, the transition approach proposes the utilization of existing liquid hydrocarbon fuels, such as gasoline and methanol, to power hydrogen fuel cell vehicles. Such a method circumvents the need to establish a direct hydrogen-fueling infrastructure, by leveraging society's existing liquid fuel distribution system.

One approach employs on-board fuel reformers that operate while the vehicle is running, converting these hydrocarbon fuels to a hydrogen-rich gas stream (a typical stream consists of 75% hydrogen, 0.4% CO, with the rest being CO₂). This reformate stream is, in turn, delivered to the vehicle's fuel cell power plant.

The leading fuel processor technologies employ partial oxidation and high-temperature steam reforming. Epyx has developed a multiple-fuel processor (gasoline, ethanol, methanol, natural gas, propane) employing partial oxidation. Teagan, W. P., Bentley, J and Barnett, B., Cost Reductions of Fuel Cells for Transport Applications: Fuel Processing Options. J. of Power Sources, 71, pp. 80-85 (March 1998). Hydrogen Burner Technology Inc. has also scheduled the first pre-commercial prototypes of its F³P fuel processors.

Despite recent breakthroughs and support from the US Department of Energy, reforming processes still result in the generation of GHGs and other harmful emissions. While on-board reforming has the benefit of providing an immediate solution to early adopters of FCVs, it re-introduces some of the problems that FCVs were designed to eliminate—namely the environmental and geopolitical concerns associated with the utilization of oil. While the use of methanol, instead of gasoline, partially addresses these concerns; it creates the need to implement an entirely new methanol-refueling infrastructure. The significant cost associated with this undertaking is an anathema to oil companies. This is especially important if, as the inventors believe, methanol will only play a transitional role in the transition to an ultimate hydrogen age.

### e. Direct Hydrogen Refueling

The second approach proposes moving to a direct hydrogen refueling infrastructure at the outset. The difficulty with such approach is that there is no economic incentive to build an external infrastructure in the absence of consumer demand. A highly centralized structure, in which hydrogen is produced in large plants and shipped or piped to refueling stations seems especially problematic, because of very high start up costs. In response, various groups have proposed the decentralized production of hydrogen at the refueling point. Two principal methods of hydrogen production have been proposed.

The first approach to a decentralized, direct hydrogen fueling infrastructure involves the utilization of hydrocarbon fuels, such as methane, as a feedstock. Methane, the major component in natural gas, is readily available in most urban areas, through a pre-existing network of underground pipelines. Small scale methane reformers connected to these gas pipelines could allow local filling stations to produce hydrogen on demand. This method, however, while partially addressing some of the geopolitical concerns associated with using imported oil, once again does so at the cost of re-introducing one of the problems that FCEVs were designed to eliminate—namely environmental concerns associated with the utilization of hydrocarbon fuels.

The second approach to a decentralized, direct hydrogen fueling infrastructure involves producing hydrogen through the electrolysis of water. In such process, electricity is used to drive an electrolyzer that dissociates water into its component parts of hydrogen and oxygen. The hydrogen is pressurized and used to refuel vehicles. Stuart Energy Systems, of Ontario, has implemented hydrogen fuel cell bus refueling stations using this approach. While it costs more to produce hydrogen through electrolysis than it does through methane reformers, the approach has the advantage of potentially eliminating the use of hydrocarbon fuels. Furthermore, if the electricity is produced through means such as solar, wind, hydroelectric, geothermal or nuclear, then harmful atmospheric emissions are removed throughout the entire energy chain. The decentralized electrolyzer approach minimizes infrastructure costs, because it relies on using only electricity and water as feedstocks, both of which are ubiquitous in urban areas.

### On Board Hydrogen Production Utilizing Electrolysis

For the aforementioned reasons, decentralized production of hydrogen through the electrolysis of water is the approach favored by the inventors. However, the inventors believe that such approach is most effective if the fuel cell vehicle generates its own hydrogen fuel on board, from externally supplied water and electricity. Consequently, such vehicles become electrically rechargeable, and the rates at which they are able to buy electricity have a major bearing on their economic viability.

### g. Restructured Electricity Markets

Electricity rates tend to be the lowest in restructured, competitive electricity markets. In many areas throughout North America, local electric utility monopolies are being forced to restructure, in order for consumers to benefit from price competition. The advantages of restructured electricity markets include:

1. lower electricity prices, which make RFCVs more economical to operate;

2. the ability to select electricity that has been produced in an environmentally friendly manner;

3. the capacity of parties other than the local utility to sell electricity and

4. a streamlined process of settling accounts between various parties to an energy transaction.

Restructured electricity markets take many forms throughout the world. The varied approaches to restructuring have to do with whether the original utility structure was totally or partially a government-owned monopoly, to what extent there was vertical integration (generation, transmission, distribution and retail customer service in one entity) and whether it was regulated or operated on a state-by-state or national basis. Britain and Wales, in 1990, became the first countries to restructure their electricity markets and promote competition. They adopted a process of gradually phasing-in competition, which is still underway. To date, other countries that have restructured electric markets include Norway, Sweden, Argentina, New Zealand and Australia.

In the United States, some of the earliest steps toward restructuring the electric utility industry were taken in 1992. In that year, Congress passed the Energy Policy Act, which authorized the Federal Energy Regulatory Commission (FERC) to provide open-access transmission of electricity. In 1996, the FERC ordered electric utilities nationwide to allow other electricity providers to transmit electricity through utility transmission systems—in effect, opening wholesale electricity markets to competitive power-generation suppliers. Now, all 50 states are working on plans to open the power generation portion of their retail electric market to competition. Utilities' transmission and distribution systems remain, for now, regulated.

California is the first open retail electricity market in the United States. But with an annual generation load of over 200 tera-watthours having a value of $28.5 billion/year, California is the largest restructured retail electric market, open to all classes of customers. According to the California Public Utilities Commission (CPUC), which regulates investor-owned electric utilities in California, the high cost of electricity is the reason behind deregulation of retail electricity markets. In describing its decision, the CPUC wrote: “utilities and other companies in areas where electricity is less costly to produce will be able to sell cheaper electricity to areas where it is more expensive to produce electricity. As a result, prices should drop.” The explanation of restructured electricity markets which follows is based on the California model.

In California, electricity restructuring has had the effect of “unbundling” the vertically integrated power monopolies, and opening them to competition. These regulated monopolies, otherwise known as the local electric utilities or investor-owned utilities, include Pacific Gas & Electric (PG&E; San Diego Gas & Electric (SDG&E); and Southern California Edison (SCE).

In such unbundled environment, vertically integrated Power Utilities are split into separate units, each of which has a separate function. The electricity industry as a whole is divided into these functional areas: generation; transmission; distribution; retail customer service; power production scheduling and electricity trading.

(i) “Generation” is the production of electricity. In a restructured market many independent power producers or “Generators” exist. Some Generators may produce electricity in a sustainable or environmentally friendly manner. Electricity produced from small-scale hydroelectric dams, or through means employing wind, solar or geothermal energy is considered environmentally friendly. Such producers are referred to herein as “Green Generators”, and are said to be producing “Green Electrons”.

(ii) “Transmission” refers to the delivery of electricity from Generators to Local Utility Distribution Companies. Transmission occurs through the electricity transmission grid, or “power grid”. The “Independent System Operator” manages the electricity transmission grid, and provides equal open access to all parties.

(iii) “Distribution” refers to the distribution of electricity from the main power grid to local grids and to individual customers. The “Utility Distribution Companies” distribute or deliver electricity to customers within their service territory. They meter the energy delivered to customers and issue bills. PG&E, SCE and SDG&E are utility distribution companies.

(iv) “Retail customer service” involves selling electricity to retail customers and administering the accounts. Energy Service Providers “(ESPs”) are retail marketers of electricity who buy power for, and market power to, retail customers. They aggregate retail power demands and buy electricity in bulk, typically from the Power Exchange (“PX,” below). ESPs bill retail customers and schedule load and generation through a Scheduling Coordinator such as the PX.

(v) “Power production scheduling” involves scheduling power generation to meet customer demand. This function is performed by “Scheduling Coordinators”, who provide balanced schedules (where generation is matched with demand and settlement ready meter data) to the Independent System Operator. Further, Scheduling Coordinators settle accounts between Generators, the Power Exchange and Electricity Service Providers.

(vi) In a restructured electricity market, electrical power may be bought and sold on the open market like any other commodity. Such “electricity trading” is conducted through an exchange, which operates in a similar fashion to a commodities exchange. This Power Exchange (“Px”) is used by Scheduling Coordinators, Electricity Service Providers and electricity Generators to buy and sell electricity. In California, 80% of generated electricity is traded through the Power Exchange. The Power Exchange functions much like a commodities market, creating a spot market for electricity and settling trades between counter-parties. The Power Exchange, like other commodities markets, is open to market speculators.

### h. Conventional Schemes For Vehicles Using Alternative Fuels

Barclay, U.S. Pat. No. 5,505,232, discloses an integrated method for on-site natural gas (NG) liquefaction and vehicle refueling. Under this scheme, small-scale liquefiers are connected to natural gas grids. Energy accumulation and storage is accomplished by the liquefaction of natural gas at the point of refueling. Refueling itself is subsequently achieved via normal means (e.g., delivery of compressed or liquefied NG to storage tanks on-board the vehicles). These authors do not disclose a method for connection to a data network or the generation of fuel on-board.

Stuart Energy Systems Inc. of Toronto, Canada, has publicly disclosed a refueling method for FCVs operating on hydrogen. In their proposed method, hydrogen fuel is produced within external stationary electrolyzers, compressed, and subsequently stored in pressurized vessels. Vehicle refueling is then achieved using methods similar to those employed by Barclay.

Werth discloses a method for generating hydrogen on-board a FCV in U.S. Pat. No. 5,830,426, U.S. Pat. No. 5,690,902, and U.S. Pat. No. 5,510,201. Werth's method is not based on electrolysis: it uses solid, metallic particles as the raw materials for hydrogen production. These patents disclose neither a link between electricity grids and vehicular refueling, nor a method for data exchange via digital networks.

Detailed analysis performed in 1994 at Lawrence Livermore National Laboratory (LLNL), determined that fuel cells can be designed to run in reverse to function as electrolyzers, thereby generating hydrogen fuel from electricity and water. LLNL determined that such systems, termed Unitized Regenerative Fuel Cells (“URFCs”) are lighter and less complex than regenerative fuel cell systems that employ separate (discrete) stacks as fuel cells and electrolyzers. Mitlitsky, F., Myers, B. and Weisberg, A. H., Regenerative Fuel Cell Systems, Energy & Fuels, 12, pp. 56-71 (1998). General Electric has performed some work on URFCs as early as 1972 with moderate success. Most experimental work in the 1990's has been performed at LLNL with support from NASA and the DOE.:

In collaboration with Proton Energy Systems, a modified primary fuel cell rig with a single cell has been operated reversibly for thousands of cycles at LLNL with negligible degradation. The URFC uses bi-functional electrodes (oxidation and reduction electrodes reverse roles when switching from charge to discharge, as with a rechargeable battery) to achieve both the fuel cell and electrolyzer functions.

Corfitsen, U.S. Pat. No. 5,671,786, discloses an apparatus for automatic refueling of vehicles. This invention is directed to traditional, liquid fuels and the refueling process is achieved by a mechanical, robotic head. This patent discloses a method for data exchange between transponders in the vehicle and the stationary refueling device. It does not disclose a connection to a widespread communications network.

Svedoff, U.S. Pat. No. 5,684,379, discloses a unidirectional device and procedure for recharging electric vehicles; it does not disclose the incorporation of a communications network for information exchange.

Nor and Soltys, U.S. Pat. No. 5,594,318, disclose a method for charging a battery with inductive coupling.

Cocconi, U.S. Pat. No. 5,341,075, discloses a combined motor drive and battery recharge system. In this invention, the motor is operated reversibly and used as a generator.

In U.S. Pat. No. 5,099,186 and U.S. Pat. No. 4,920,475, Rippel et al. disclose integrated drive and recharging systems. Neither Rippel et al., nor Cocconi disclose a method for generating chemicals on-board a vehicle, or the management of energy transactions through a digital communications network.

Finally, a method for computerized billing has been disclosed by Crooks et al., in U.S. Pat. No. 5,943,656 and U.S. Pat. No. 5,930,773, issued 24 Aug. 1999 and 27 Jul. 1999, respectively. These inventors do not disclose a connection between the electricity and transportation markets and do not make a distinction between electricity generated from sustainable sources, and electricity generated from traditional (fossil) sources.

### SUMMARY OF THE INVENTION

The present invention provides a system and method for FCVs to automatically generate their own hydrogen fuel on board from externally supplied electricity and water. Such vehicles, which the inventors term “regenerative fuel cell vehicles”, or “RFCVs”, eliminate the requirement for a costly hydrogen-refueling infrastructure. Networks of external electrolyzers and associated hardware are not necessary because RFCVs effectively carry their own infrastructure on-board. Refueling is accomplished through the utilization of existing distribution systems for electricity and municipal water. In a preferred embodiment, the present invention further provides a system and method for the RFCVs to automatically deliver electricity which they generate to local non-utility electrical distribution systems.

A preferred embodiment of the invention provides a novel method for integrating RFCVs with such distribution systems, and for automatically managing the ensuing energy delivery transactions, through the utilization of restructured electricity markets and digital data networks.

The present invention provides a system including a plurality of geographically distributed Composite Currency Ports (“Ports”) to which RFCVs or other portable fuel cell powered devices can be connected. These Ports, in turn, connect to existing electricity grids, data networks and municipal water systems and effectively combine and integrate electricity, data and water to create a new composite energy currency, referred to as the “Composite Currency”, specifically suited to RFCVs or other portable fuel cell powered devices. The Port connects to a Composite Currency Port Controller (“Port Controller”), which regulates and meters the flow of electricity and acts as a conduit for digital data transmission between the vehicle and the parties involved in the energy delivery process. Through these Ports, the RFCV can receive electricity and water for the purposes of fuel production, or alternately, deliver internally generated electricity to a local non-utility electrical system.

When electricity rates are low (for example, from 12:00 AM to 6:00 AM), the RFCV can absorb water and electricity, to produce and store hydrogen. A 250 kiloWatt connection allows a Class 7 truck, during a six hour refueling cycle, to create sufficient hydrogen to achieve a 300 mile range. Further, the same connection, during peak periods of electricity usage, allows the FCEV to generate electricity that can be supplied back to local electricity networks, thereby displacing demand for electricity from central power grids.

Management of the financial transactions associated with such energy delivery is an aspect of the invention. Since FCVs will typically consume and/or produce electricity at levels between 75 and 250 kilowatts for several hours, the dollar amounts associated with such transactions are significant.

Because a vehicle is inherently mobile, it will potentially be connected to a multiplicity of Ports throughout its operating lifetime. As such, it is likely that the owner of the vehicle and the owner of the premises in which the Port is installed will be unrelated parties. Therefore, an aspect of the invention is the automated management of the financial transactions occurring between the multiple unrelated parties to the energy delivery transaction.

Such parties include the RFCV, the RFCV's owner, the RFCV's ESP, the Port, the Port's owner, and the Port's ESP. An aspect of the invention is that it provides a method for these multiple parties to automatically negotiate the purchase and sale of electricity, and settle their transactions. Automated information (data) exchange is particularly important for RFCVs, which typically receive energy for refueling during the middle of the night when electricity cost is lower. A data network, preferably a wide area computer network such as the Internet, provides a suitable medium for such automated information exchange in accordance with the present invention, by providing a low cost, easily accessible data communications network for all parties concerned. Thus, a preferred embodiment of the present invention has all parties connected to one another via the Internet. This embodiment is compatible with current trends, where electricity purchase and sale transactions within restructured electricity markets are increasingly conducted via the Internet.

The invention provides a system and method for Ports and the networks to which they are connected, to function as automated energy brokers—selling electricity to vehicles that require refueling, and buying electricity from vehicles that are generating it for the purpose of resale. Further, a preferred embodiment of the invention provides a method for RFCVs to purchase only Green Electrons, ensuring that harmful emissions are eliminated throughout the energy chain.

Because the Port and Port Controller are essentially solid state electronic devices, it is expected that they would be mass produced at costs sufficiently low to make them readily affordable consumer items. Consequently, they could be rapidly installed in both commercial and residential locations, giving them the potential to facilitate the rapid deployment of a hydrogen refueling infrastructure at a minimum economic cost. The invention provides a solution to the refueling needs of the first FCV customer, because a single Port installed at the RFCV owner's place of business or residence could in theory fulfill most of the local refueling requirements for the vehicle. This overcomes the major difficulty in introducing FCV's, which is the lack of a pre-existing refueling infrastructure.

The system and method of a preferred embodiment of the present invention includes configuring fuel cell vehicles to generate their own hydrogen fuel on board. Such configuration of a fuel cell vehicle suitably incorporates the following internal systems.

1. a system to dissipate heat generated by the electrolytic process;

2. a system to convert external AC current to DC current, to power the electrolytic process;

3. a system to filter and deionize the water used in the electrolytic process;

4. a system to electrolytically separate water into its constitutive elements, of hydrogen and oxygen; and

5. a system to compress the hydrogen that is produced.

While the vehicle is in a stationary refueling mode, its existing cooling system is underutilized and can be employed as the heat dissipation system for the electrolytic process. This eliminates the need for a separate heat dissipation system.

Since many FCV's employ an AC induction motor, and fuel cells generate DC electricity, a FCV typically employs a DC to AC power converter. Such power converter can be constructed to function in inverse mode, as an AC to DC power converter, without appreciably adding to its size. Such a device, which can switch its mode of operation under software control, eliminates the need for an additional system to convert external AC current to DC current to power the electrolytic process.

A system to filter and deionize water used in the electrolytic process is readily achieved using a small filter column that can be easily fitted on board the vehicle.

In the preferred embodiment of the present invention, the electrolytic separation of water and the compression of resulting hydrogen are both be achieved in a single device—thus eliminating the need for two separate systems. This device, a PEM electrolyzer (“PEME”) operates in an analogous but inverse manner to the PEM fuel cell. Water flowing through the PEME's membrane electrode assembly, in the presence of an externally applied electrical current, dissociates into hydrogen and oxygen gas streams. PEMEs are particularly appropriate for on board hydrogen production for three reasons:

1. It is reasonable to expect that PEMEs, which are essentially based on the same technology as PEMFCs, will achieve similar energy densities. PEMFCs today exceed energy densities of 50 kW per cubic foot. Automobiles typically require 50 kW engines, and trucks typically require 250 kW engines. Thus PEMEs typically add component volume of 1 to 5 cubic feet for cars and trucks respectively. Such volume is easily manageable.

2. The PEM electrolyzer is capable of compressing the hydrogen gas it generates to pressures exceeding 2000 pounds per square inch (“psi”), by using purely electrochemical processes. This eliminates the need for a mechanical compressor. While it is expected that PEMEs can achieve even greater pressures, 2000 psi is adequate for many vehicle applications, such as trucks and buses.

3. By integrating PEMFC stacks with PEME stacks, it is possible to design systems that can both produce electricity from hydrogen and oxygen fuel, and electrolytically regenerate this fuel from electricity and water. Such a system is termed a regenerative fuel cell system. When it employs a single stack that is run reversibly to function as either a PEMFC or a PEME, it is termed a unitized regenerative fuel cell (“URFC”) system. URFCs have the potential to eliminate the added weight and volume of the PEME, by effectively absorbing it into the PEMFC.

The present invention, offers the following advantages over other proposed direct hydrogen refueling infrastructures for FCVs:

i) No Pre-Existing Hydrogen Infrastructure Necessary. The FCVs refueling needs can in principal be entirely met by the owner's Port alone, eliminating the need for a pre-existing infrastructure;

ii) Low Cost. Each Port refueling station, by virtue of its relative simplicity and minimum component count, has the lowest unit cost of any proposed refueling option;

iii) Scalability. Mass-produced as consumer items, the population of Ports can be quickly and easily expanded to match the growth of FCV sales.

iv) Serviceability. Since the bulk of the re-fueling infrastructure resides on-board the vehicle, Ports systems are extremely simple. They preferably have no moving parts, consist of solid-state electronics and consequently have minimum service requirements.

v) Zero Footprint. Since preferred embodiments of Ports can be flush mounted within the floors or walls of vehicle parking stalls; they take up no room and do not impinge upon parking space or impede vehicle flow.

vi) Increased Safety. The only materials delivered to the vehicle are electricity and water. The fuel production and storage systems are hermetically sealed and inaccessible to the driver or operator. Because the fuel is produced on-board, operators of the vehicle are never in direct contact with the fuel.

vii) Reduced Evaporative Emissions. During normal refueling, conventional gaseous or liquid fuels are always liberated into the environment. Gaseous fuels such as methane, dissipate quickly and contribute to atmospheric pollution. Spillage of liquid fuels such as gasoline result in contamination of water and sewage systems and, through evaporation, also contribute to atmospheric pollution. In contrast, electrolytical hydrogen produced on-board can be completely isolated from the outside of the vehicle, thereby eliminating the possibility of escape during normal operation.

viii) Regenerative Braking. The RFCV is able to employ regenerative braking to produce electricity that can power the PEME to produce additional hydrogen fuel. In regenerative braking, the vehicle's rotating wheels operate the electric drive as a generator to produce electricity, thereby creating a negative torque which impedes motion.

ix) Green Electrons. The method of energy delivery optionally employed by a preferred embodiment of the present invention takes advantage of the benefits of a restructured electricity market. One such benefit is that a consumer may specifically choose “Green Electrons.” Likewise, the RFCV, operating in such an environment may specifically choose “Green Electricity.” This ensures that the FCV does indeed result in zero emissions across the entire energy chain.

The present invention thus provides a system and method for the distribution of electrical energy from hydrogen fuel cell powered devices. The system includes a station including an external port coupled to an external port controller and a water supply. The external port controller is connected to an electricity power grid. The port controller controls the supply of electricity from the electricity power grid to the external port. The hydrogen fuel cell powered device has an internal port for receiving electricity and water to be utilized by the device's onboard fuel plant for the internal generation of hydrogen fuel. An internal controller within the device controls aspects of the supply of electricity and water to the device. A connector is provided for coupling the station's external port to the device's internal port for the supply of electricity and water therebetween, under the control of the external port controller and/or the internal controller.

In a further aspect of the present invention, the system and method further include a data link for transmitting data between the external port controller and the internal controller attendant to the supply of electricity to the device. In a preferred embodiment, the data link is incorporated into the connector with data being transmitted between the external port controller and the internal device controller via the connected external port and internal port.

In a further aspect of the present invention, a system and method are provided for distribution of electricity from at least one electricity service provider to portable hydrogen fuel cell powered devices. The system includes at least one station having an external port coupled to the electricity supply grid through an external port controller, which controls the supply of electricity through the external port, and a data link for transmitting data, attendant to the supply of electricity, between the external port controller and the at least one electricity service provider via a data network. The hydrogen fuel cell powered device's internal port for receiving electricity is also included. An internal controller within the device is connected to control aspects of the supply of electricity to the device. A connector is provided for coupling the external port to the internal port for the supply of electricity therebetween, the electricity being supplied from at least one electricity service provider to the device under the control of the external port controller and/or the internal controller in communication with at least one electricity service provider over the data network.

In a further aspect of the present invention, a system and method are provided for a hydrogen fuel cell powered device to automatically negotiate the purchase of electricity from one or more electricity service providers, where such electricity is delivered over an electricity network. The system includes an external port coupled to the electricity supply grid, through a port controller, and an internal port within the hydrogen fuel cell powered device and connectable to the external port to receive electricity therefrom. The external port controller controls the supply of electricity through the external port. An internal controller within the device is connected to control aspects of the purchase of electricity via the connected internal port. The external port controller and/or the internal controller provide for automatic negotiation between at least two of the following parties for the purchase and delivery of electricity from an external electricity network to the device via the connected ports: one or more electricity service providers, the external port controller and the internal port controller.

In a further aspect of the present invention, a system and method are provided for the supply of electricity between an electricity network and a portable hydrogen fuel cell powered device. The system includes an external port coupled to the electricity network, an internal port within the hydrogen fuel cell powered device and connectable to the external port for the flow of electricity therebetween, and a controller coupled to one of the external port and the internal port. The controller is operable to selectively initiate and control (i) the supply of electricity from the electricity network to the device, and (ii) the delivery of electricity generated by the device to the electricity network.

In a further aspect of the present invention, a method for distributing electricity over an electricity grid from a plurality of electricity generators to a portable hydrogen fuel cell powered device is provided. The plurality of electricity service generators include a first subset of generators that generate electricity without producing atmospheric pollutants in the course of generation and a second subset of generators that do emit atmospheric pollutants during electricity generation, such as fossil fuel based generators. A port on the portable hydrogen fuel cell powered device is suitably coupled to the electricity supply grid, and influences the aggregate of the sources of electricity supplied to the grid to increase the supply from the first subset of generators.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial representation of the Hydrogen/Electric Energy Distribution System.

FIG. 2 is a schematic representation of the water, electricity, data, and monetary flows associated with a transaction under the Networked Refueling Mode of Operation.

FIG. 3 is a schematic representation of the water, electricity, data, and monetary flows associated with a transaction under the Networked Generation Mode of Operation.

FIG. 4 is a schematic representation of the water, electricity, and data flows associated with a transaction under the Local Refueling Mode of Operation.

FIG. 5 is a schematic representation of the water, electricity, and data, and monetary flows associated with a transaction under the Local Generation Mode of Operation.

FIG. 6 is a schematic representation of the System Schematics.

FIG. 7 is a schematic representation of the Fuel Subsystem Schematics.

FIGS. 8A and 8B are bottom and side views, respectively, of a Composite Currency connection cable;

FIG. 8C is a top view of a Composite Currency Port of the present invention; and

FIGS. 8D and 8E are schematic longitudinal cross-sectional views of an external Composite Currency Port and vehicle-mounted Composite Currency Port, respectively.

### DETAILED DESCRIPTION OF THE PREFERRED EMBODIMENT

### a. Composite Currency Delivery System

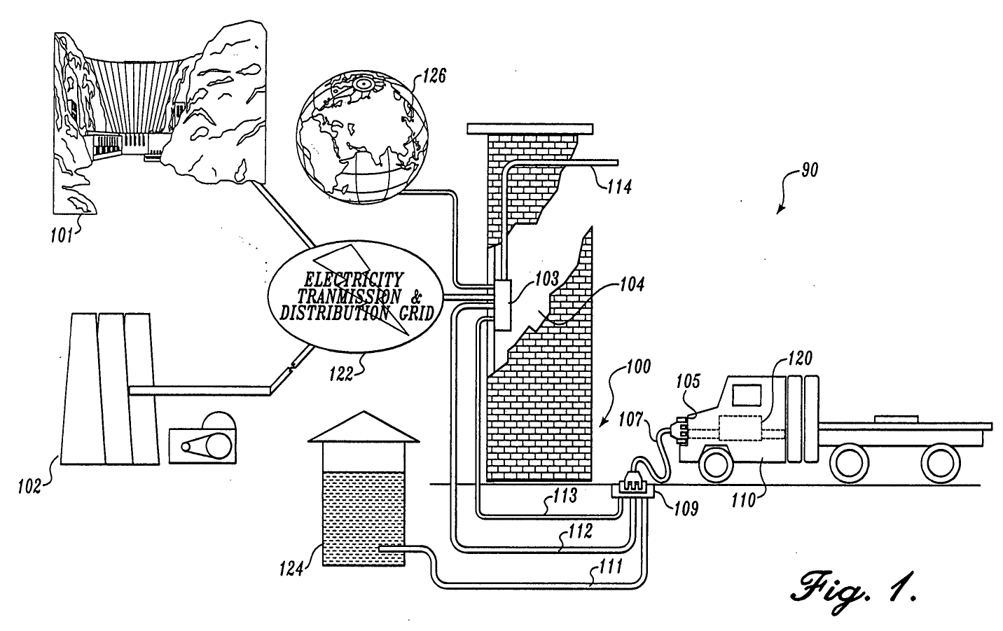

FIG. 1 provides a pictorial representation of a preferred embodiment of the energy distribution system of the present invention. The energy delivery system 90 provides a plurality of energy delivery stations 100, one of which is illustrated in FIG. 1. The energy delivery stations 100 are distributed throughout a geographic area, and are provided for the purpose of delivering energy to portable hydrogen-fueled devices. In the preferred embodiment of the invention described herein, the devices are as regenerative fuel cell vehicles (RFCVs) 110. While the system described herein is disclosed in terms of an RFCV 110, it should be understood to also have applicability for other portable hydrogen fueled devices, motorized or otherwise. Further, while the preferred embodiment is described and illustrated in terms of a regenerative fuel cell vehicle, and particularly proton exchange membrane fuel cells and electrolyzers, the present invention is adaptable for use with vehicles or devices that use alternative methods of storing or generating hydrogen.

The RFCVs 110 serviced by the system and method of the present invention each carry an onboard electrolytic hydrogen production plant 120. Composite Currency for hydrogen production, preferably in the form of electricity and water, is supplied to the hydrogen production plant 120 through a composite currency port 105 built into each RFCV 110. Composite currency is suitably delivered to the RFCV port 105 via a Composite Currency cable 107 that is connected, either manually or in an automated fashion, to a stationary Composite Currency Port 109 provided at the station 100. The stationary Composite Currency Port 109 at the station 100 in turn is supplied with water from a municipal water supply 124 or other water supply, such as a well, reservoir or treatment plant, and with an electricity and data connection through a Composite Currency Port Controller 103. The Composite Currency Port: Controller 103, is in turn connected to an electricity transmission and distribution grid 122, a non utility electricity distribution system (e.g., the building's internal electrical system or the wiring of one or more appliances, etc.) and a wide area data network, suitably the Internet 126. The Composite Currency Port Controller 103 exchanges data with the RFCV and the data network to negotiate and control the purchase and delivery of electricity between the RFCV and the external Composite Currency Port 109 at the station 100. These aspects of the present invention will now be described in further detail.

The RFCV 110 connects through its internal Composite currency Port HP 105 to the external Composite Currency Port 109 through the Composite Currency Cable 107, that supplies the RFCV 110 with a connection for water 111, electricity 112 and data 113. The Composite Currency Port Controller 103, preferably located in a premises equipment closet 104 of the station 100, continuously polls the external Composite Currency Port 109 to establish when a vehicle has been physically connected to it. When the Port Controller 103 senses such physical connection, the Port Controller 103 and the RFCV 110 exchange data, via a data link within the Composite Currency Cable 107 (which connects the vehicle to the external Composite Currency Port) and the data link 113 (which connects the external Composite Currency Port to the Port Controller 103). The devices communicate using a pre-established handshaking protocol. During this handshaking, the Port Controller 103 instructs the vehicle whether to operate in a networked state (the preferred mode and the one shown in the diagram) or a local state (an alternate mode which applies if the Port Controller is not connected to a digital data communications network such as the Internet). Preferably all networked data communications utilize transactional security measures, such as authentication and/or encryption.

The RFCV itself preferably has two primary states of operation: Refueling and Generating. Combining such states, leads to the following four modes of RFCV operation in the preferred embodiment: Networked Refueling; Networked Generation; Local Refueling; and Local Generation. While these four modes are preferred, systems capable of fewer modes are also within the scope of the present invention, e.g. refueling only without generation.

When the RFCV 110 is operating in the Networked Refueling Mode in a restructured electricity marketplace (such as California), the vehicle has the option of choosing to purchase electricity only from Green (renewable) Electricity Generators 101, as opposed to, for example, Fossil Fuel Based Electricity Generators 102. While Green Electricity Generators are preferred for environmental concerns, both types of electricity sources are within the scope of the present invention.

In the preferred embodiment described, communication between the port controller 103 and electricity service providers (ESPs) takes place over a data network, particularly the Internet 126. Alternately, this communication between the port controller 103 and ESPs may take place over a wireless data link. Similarly, the internal controller of the RFCV 110 may communicate directly with the ESPs over a wireless data link.

In a further aspect of the present invention, the connection of the internal controller of the RFCV 110 to the Internet 126 via the cable 107 and external port controller 103 provides the opportunity for the transmission of other types of data between the RFCV and the Internet. By way of nonlimiting example, digital information such as music programming or digital maps can be downloaded over the Internet to the RFCV, and vehicle performance data can be uploaded from the RFCV over the Internet. This provides the opportunity to transmit high bandwidth data rapidly and inexpensively.

### b. Networked Refueling Mode

In the Networked Refueling Mode, the RFCV replenishes its hydrogen reserve, by automatically generating the fuel on-board from electricity and water. The Networked Refueling Mode is the preferred method of refueling, because it automatically handles all financial transactions associated with delivering energy for the refueling process. The Networked Refueling Mode works best in a restructured electricity market because such markets: 1) typically have lower electricity prices; 2) allow the RFCV to select “green electrons” if desired; 3) allow parties other than the local utility to sell electricity; and 4) streamline the process of settling accounts between the RFCV owner and the Composite Currency Port owner. However, the present invention is also adaptable for use in traditional non-restructured electrical markets.

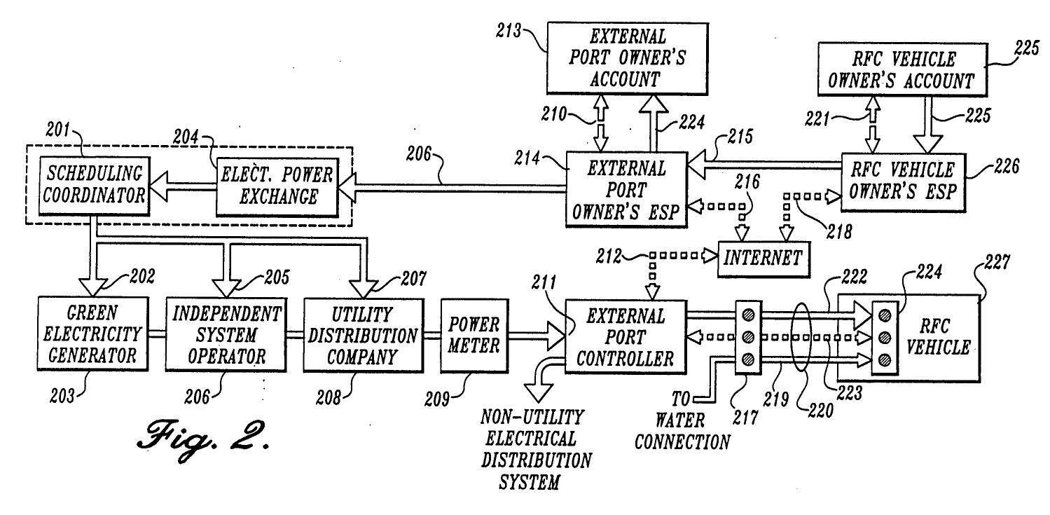

FIG. 2 illustrates the Networked Refueling Mode in a restructured electricity marketplace. In the Networked Refueling Mode, an RFCV 227 and a Composite Currency Port Controller 211, through the data link 223, exchange identification data for billing purposes. The RFCV 227 requests that the Port Controller 211 to initiate an Internet connection 212, for the purpose of connecting the RFCV 227, via the Port Controller 211, to the RFCV Owner's Energy Service Provider (VO ESP) 226. Upon connection, the RFCV identifies itself to the external Composite Currency Port 217 to which it is connected. The VO ESP 226 transmits file updates to the RFCV 227, such as the latest recorded financial transaction information.

The RFCV 227 utilizes the Internet connection established between itself and the VO ESP 226, to transmit the quantity of energy it requires. The Internet connection between the RFCV 227 and the VO ESP 226 is then terminated. The preferred embodiment described herein utilizes the external port controller to negotiate electricity purchase between the VO ESP and the PO ESP using parameters particular to the RFCV. However, other negotiation arrangements, such as by a third party broker operating between the VO ESP and the PO ESP, or the PO ESP and the RFCV directly, are also within the scope of the present invention. Further, rather than the external port controller controlling the negotiations, the computer onboard the RFCV can control the negotiation.

The VO ESP 226 accesses the RFCV owner's account 225 to establish parameters such as the owner's time of day fueling preferences, the maximum price it will pay for energy and whether “Green Electricity” (electricity produced from environmentally friendly sustainable sources) is required. It utilizes this information to create an energy purchase request.

The VO ESP 226 then establishes an Internet connection to the external (i.e., stationary) Composite Currency Port owner's Energy Service Provider (“PO ESP”) 214, and submits the energy purchase request to the PO ESP 214. The PO ESP 214 accesses the Composite Currency Port Owner's account 213 to establish the Composite Currency Port owner's criteria for selling energy. Based upon this criteria, and the availability of the type of energy requested (i.e. “Green Electricity”), the PO ESP 214 provides a delivery price to the VO ESP 226. Based on the RFCV owner's pricing preferences, the VO ESP 226 may accept the delivery price, or negotiate further with the PO ESP 214. Such negotiations may include specifying a different quantity of energy and/or a different delivery period. If the negotiations are completed successfully between the VO ESP 226 and the PO ESP 214, then the VO ESP 226 issues, over the Internet connection, an electronic energy purchase order to the VO ESP 226, based on the agreed quantity of energy, delivery time frame and price. The Internet connection between the VO ESP 226 and the PO ESP 214 is terminated.

The PO ESP 214 establishes an Internet connection 216 with the Port Controller 211. It tells the Port Controller 211 the time at which to begin energy delivery and the quantity of energy to be delivered. The Internet connection between the PO ESP 214 and the Port Controller 211 is then terminated.

At the prescribed delivery time, and via the data link 223, the Port Controller 211 notifies the RFCV 227 that it is ready to begin energy delivery. Upon the RFCV 227 requesting energy transfer initiation, the Port Controller 211 energizes the external Composite Currency Port 224 to deliver electricity to the RFCV 227 The electricity 222 and water 219 pass from the external Composite Currency Port 217, through a Composite Currency Cable 220, where these raw materials are accepted by the RFCV's internal Composite Currency Port 224. The RFCV 227 uses these feed stocks for the on-board production and storage of hydrogen fuel. When the Port Controller 211 registers that the required energy has been delivered, it de-energizes the external Composite Currency Port 217.

At such time, the Port Controller 211 establishes an Internet connection with the PO ESP 214. The Port Controller identifies both itself and the RFCV 227, the date and time of energy delivery and the quantity of electricity supplied. The Internet connection between the PO ESP 214 and the Port Controller 211 is then terminated.

The PO ESP 214 records the energy delivery transaction, posts the transaction to the Composite Currency Port owner's account 213 and credits the Composite Currency Port owner's account 225 for the appropriate amount of the fees earned for the energy transaction. The PO ESP 214 then generates an invoice to VO ESP 226.

The PO ESP 214 then establishes an Internet connection 216 with the VO ESP 214 and issues, over the Internet connection, an electronic invoice. The VO ESP 226 over the Internet connection, makes electronic payment arrangements with the PO ESP 214. The Internet connection between the VO ESP 226 and the PO ESP 214 is terminated.

The VO ESP 226 passes the charges along to the RFCV owner, by posting the transaction to the RFCV owner's account 225, debiting the account for the appropriate amount of the charges.

Finally, the VO ESP 226 establishes an Internet connection 216 with the Port Controller 211, through which it connects to the RFCV 227, where it reports the financial transaction the RFCV 227.

At this point Refueling Mode operation is complete. FIG. 2 illustrates how the exemplary transaction relates to all the other parties involved in a restructured energy marketplace (based by way of example on the California model).

In such marketplace, the PO ESP 214 will periodically read the Composite Currency Port owner's Power Meter 209 and use this information to generate a bill to the external Composite Currency Port owner, for the premises total electricity consumption during the billing period. The bill will include charges for the total amount of electricity delivered to vehicles through the Composite Currency Port 217. However, these charges will be offset by corresponding credits. These aggregate credits will equal or exceed the aggregate charges, because Composite Currency Port owners have the option of “marking up” the energy they sell This would apply, for example, for Composite Currency Ports installed in a hotel or motel, where refueling services were offered to registered guests.

Finally, the Port Controller ESP 214 is responsible for paying the Electricity Power Exchange 204 for the aggregate of the energy, transmission and distribution charges that it has purchased on behalf of its retail customers. In turn, the Power Exchange 204, functioning as a Scheduling Coordinator 201, settles accounts (arrows 202, 205 and 207) respectively with the Electricity Generator(s) 203, the Independent System Operator 206 and the Utility Distribution Company 208.

For the purposes of generality, the above transactional account assumes that the PO ESP 214 and the VO ESP 226 are different parties. The transactional flow would be simplified if the VO ESP and the PO ESP were one and the same party (to the extent that no communication would be necessary between them), which is also within the scope of the present invention.

### c. Networked Generation Mode

In the optional Network Generation Mode, the RFCV functions as a stand-alone generator for the local electricity network. The Networked Generation Mode is a preferred method of generation, where the ability for generation is to be utilized, because it automatically handles all financial transactions associated with delivering the generated electricity to the local electricity network. The Networked Generation Mode works best in a restructured electricity market because such markets: 1) allow parties other than the local utility to sell electricity; and 2) streamline the process of settling accounts between the RFCV owner and the Composite Currency Port owner.

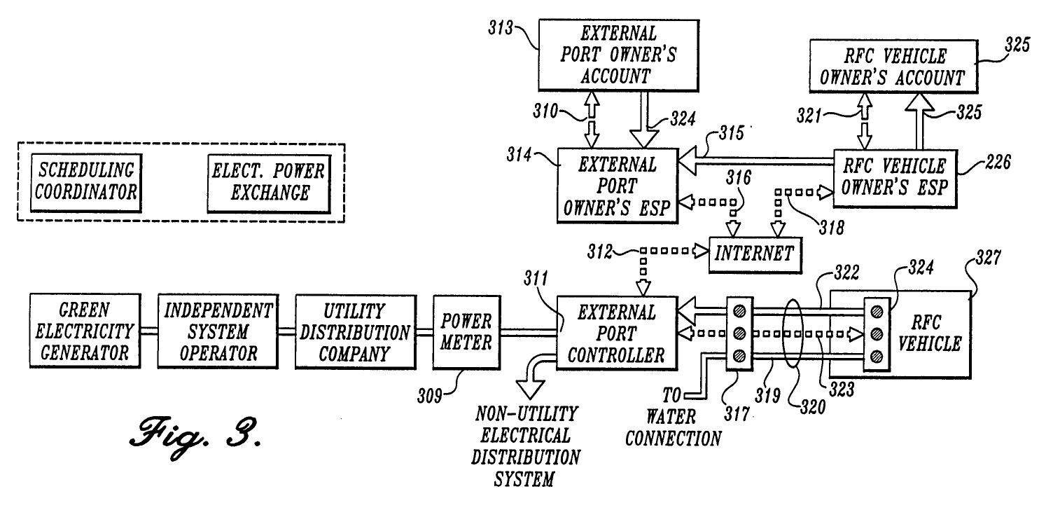

FIG. 3 illustrates the Networked Generating Mode in a restructured electricity marketplace. In the Networked Generating Mode, The RFCV 327 and the Port Controller 311, through the data link 323, exchange identification data for billing purposes. The RFCV 327 requests that the Port Controller 311 initiate an Internet connection 312, for the purpose of connecting the RFCV 327, via the Port Controller 311, to the RFCV owner's Energy Service Provider (VO ESP 326). Upon connection, the RFCV identifies both itself and the external Composite Currency Port 317 to which it is connected. The VO ESP 226 transmits file updates to RFCV 327, such as the latest recorded financial transaction information.

In the Electricity Generation Mode, the RFCV 327 utilizes the Internet connection established between itself and the VO ISP 226, to transmit an estimate of the total amount of hydrogen fuel it has stored on board. The Internet connection between the RFCV 327 and the VO ESP 326 is then terminated.

The VO ISP 226 accesses the RFCV 327 owner's account 325 to establish the owner's selling preferences. Based on the amount of hydrogen fuel reported by the RFCV 327, coupled with such factors as the vehicle's fuel usage patterns and reserve requirements, the VO ESP 326 determines the total amount of electrical energy the RFCV 327 has available for sale. The VO ESP 326 couples this information with the owner's specified price points for electricity sales, to generate an offer to sell energy to the Composite Currency Port owner.

The VO ESP 326 then establishes an Internet connection 318 with the external Composite Currency port owner's electricity service provider (PO ESP) 314, and submits the offer to sell energy to the PO ESP 314. The Internet connection is then terminated.

The PO ESP 314 accesses the Composite Currency Port Owner's account 313 to establish the Composite Currency Port owner's criteria for purchasing energy. If and when the offer to sell energy received from the VO ESP 326 matches the criteria established by the Composite Currency Port owner, the PO ESP 314 generates a purchase order to the VO ESP 326. The purchase order includes the IDs of the Port Controller 311 and the RFCV 327, the agreed purchase rate and the required date and time to start generation. Such a purchase order might be triggered, for example, when the real time electricity price of the PO ESP, which under this scheme would supply all electricity for the premises in which the Composite Currency Port was installed, exceeded the VO ESP's price by a predefined threshold.

Upon generation of the purchase order, the PO ESP 314 establishes an Internet connection 316 with the VO ESP 326. The PO ESP 314, via the Internet connection, sends the electronic purchase order to the VO ESP 326.

The VO ESP 326 in turn establishes an Internet connection 318 with the RFCV 327 via the Port Controller 311. It tells the RFCV 327 the date and time to begin electricity energy generation. The Internet connection between the PO ESP 314. and the Port Controller 311 is then terminated.

At the prescribed delivery date and time, and via the data ink 323, the RFCV 327 notifies the Port Controller 311 that it is ready to begin energy delivery. Upon the Port Controller 311 requesting energy transfer initiation, the RFCV 327 energizes its internal Composite Currency Port 324 to deliver electricity to the Port Controller 311. Electrical energy is supplied from the internal Composite Currency Port 324, through the Composite Currency Cable 320, where it is accepted by the external Composite Currency Port 317. The external Composite Currency Port 317 conducts this energy to the Port Controller 311. The Port Controller 311 measures the rate at which electrical energy is being consumed by the premises, and the rate at which electrical energy is being produced by the RFCV 327. It utilizes this information to direct, in real time, total RFCV energy output, via the data link 320. It controls the RFCV's energy output, so that it matches energy consumption. At such time, the Port Controller disconnects the premises from grid power entirely.

RFCV electricity generation continues until: the PO ESP 314 sends notification to the VO ESP 326 to terminate electricity generation; or the RFCV 327 notifies the Port Controller 311 that it is about to terminate electricity generation (if, for example, it is close to the threshold of delivering the maximum available energy).

In the first case, the VO ESP 326 establishes an Internet connection with the RFCV 327 via the Port Controller 311. Via this connection, the VO ESP 326 notifies the RFCV 327 to terminate electricity generation, and the RFCV 327 notifies the Port Controller 311, via the data link 320 that it is about to terminate electricity generation.

Upon receiving such notification, the Port Controller 311 switches back to grid power, and notifies the RFCV 327 that termination had been accepted. At such point the RFCV 327 shuts off generation. The Port Controller 311 reads its internal registers to establish the quantity of electrical power delivered by the RFCV 327.

The Port Controller 311 then establishes an Internet connection 312 with the PO ESP 314. Via this connection, the Port Controller 311 provides the PO ESP 314 with its ID, the ID of the RFCV 327, the date and time of energy generation and the quantity of electricity delivered. The Internet connection between the PO ESP 314 and the Port Controller 311 is then terminated.

The PO ESP 314 then establishes an Internet connection 316 with the RFCV ESP 326, and via this Internet connection, issues an electronic record of the transaction. The VO ESP 326, via this same connection, issues an electronic invoice to the PO ESP 314. The Port Controller ESP passes the charges along to the external Composite Currency Port owner, by posting the transaction to the RFCV owner's account 325, and debiting the account for the appropriate amount of the charges. Then, via the existing Internet connection, the PO ESP 314, makes electronic payment arrangements with the VO ESP 326. The Internet connection between the VO ESP 326 and the PO ESP 314 is terminated.

The VO ESP 326 records the energy delivery transaction, posts the transaction to the RFCV owner's account 325 and credits the RFCV owner's account 325 for the appropriate amount of the fees earned for the energy transaction.

Finally, the VO ESP 326 establishes an Internet connection 318 with the Port Controller 311, through which it connects to the RFCV 327, where it reports the financial transaction to the RFCV 327.

At this point the Generation Mode of operation is complete. The rest of FIG. 2 is not applicable because the transaction occurs entirely off the grid.

For the purposes of generality, the above transactional account assumes that the PO ESP 314 and the VO ESP 326 are different parties. The transactional flow would be slightly simplified if the VO ESP and the PO ESP were one and the same party (to the extent that no communication would be necessary between them), which is also-within the scope of the present invention.

### d. Local Refueling Mode

In the optional Local Refueling Mode, the RFCV replenishes its hydrogen reserve, by automatically generating the fuel on-board from electricity and water. The Local Refueling mode does not handle financial transactions associated with energy delivery, because there is no connection to financial intermediaries.

In the Local Refueling Mode, illustrated in FIG. 4, the RFCV the Port Controller 411 notifies the RFCV 427 that it is ready to begin energy delivery. Upon the RFCV 427 requesting energy transfer initiation, the Port Controller 411 energizes the external Composite Currency Port 417 to deliver electricity to the RFCV 427. The electricity 422 and water 423 pass from the external Composite Currency Port 424, through the Composite Currency Cable 420 where these raw materials are accepted by the RFCV's internal Composite Currency Port 424. The RFCV 427 uses these feed stocks for the on-board production and storage of hydrogen fuel. When the Port Controller 411 registers that the required energy has been delivered, it de-energizes the external Composite Currency Port 417.

### e. Local Generation Mode

In the optional Local Generation Mode, the RFCV functions as a stand alone generator for the local electricity network. The Local Generation Mode does not handle financial transactions associated with energy delivery, because there is no connection to financial intermediaries. The Local Generation Mode is useful, because it allows the RFCV to provide a primary source of electricity in remote locations.

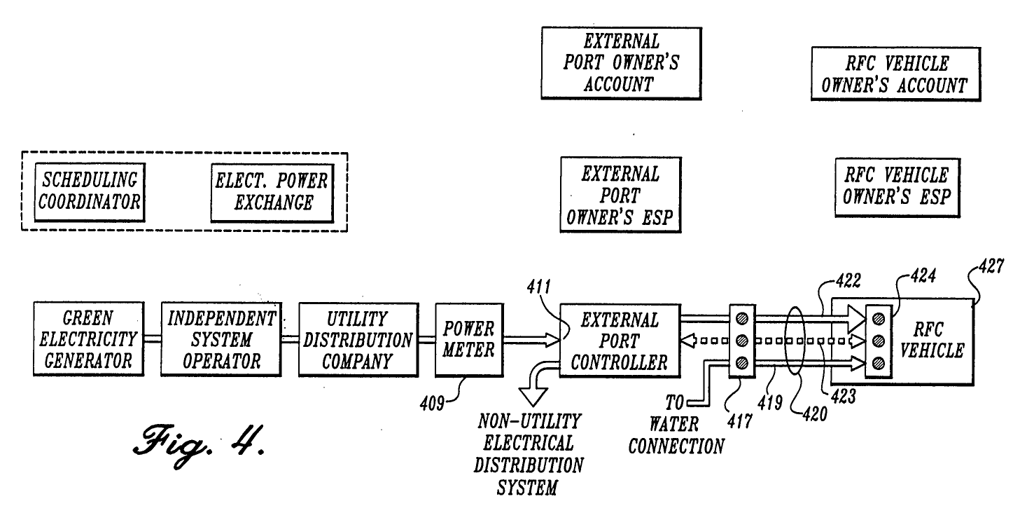

In the Local Generation Mode, illustrated in FIG. 5, the RFCV 527 notifies the Port Controller 511 that it is ready to begin energy delivery. Upon the Port Controller 511 requesting energy transfer initiation, the RFCV 527 energizes its internal Composite Currency Port 524 to deliver electricity to the Port Controller 511. Electricity is supplied from the internal Composite Currency Port 524, through the Composite Currency Cable 520 where it is accepted by the external Composite Currency Port 517. The external Composite Currency Port conducts this energy 522 to the Port Controller 511. The Port Controller 511 measures the rate at which electrical energy is drawn is being consumed by the premises, and the rate at which electrical energy is being produced by the RFCV 527. It utilizes this information to direct, in real time, total RFCV energy output, via the data link 523. It controls the RFCV's energy output, so that it matches energy consumption. At such time, the Port Controller disconnects the premises from grid power entirely.

RFCV electricity generation continues until: the RFCV 527 notifies the Port Controller 511 that it is about to terminate electricity generation (if, for example, it is close to the threshold of delivering the maximum available energy).

### f. System Schematics

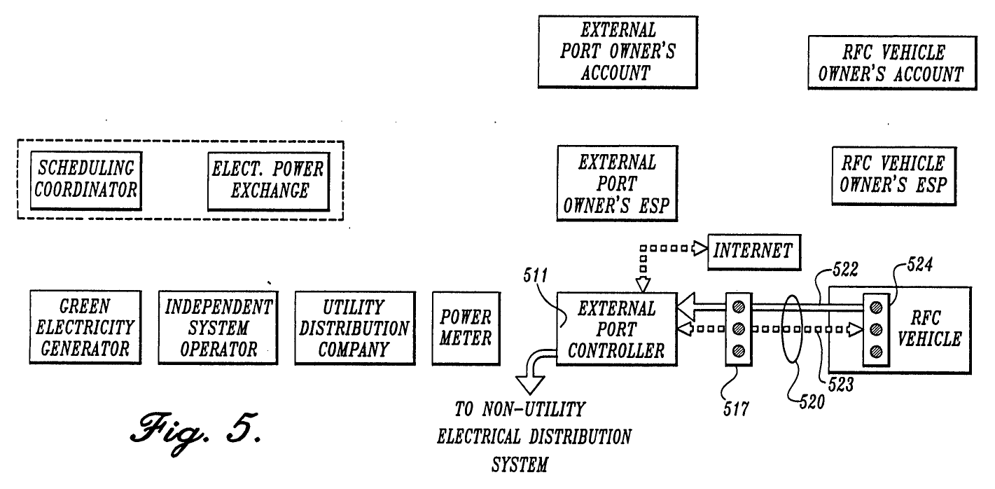

FIG. 6 illustrates schematically the preferred embodiment of the energy delivery structure of the energy distribution system 90. This structure includes an external system 601, forming the station 100, and an internal (on-board the RFCV) system 602.

The external system includes an external Composite Currency Port 604 and a Port Controller 603. In addition, the external system includes four connections to: the power grid 606 through a utility supplied power meter 605; the building's main electrical panel 607; a digital data network, such as the Internet 608; and a water source 609, such as a municipal water system.

The Port Controller is in turn constructed from two power switches 610 and 611, a rechargeable battery or equivalent electrical energy storage device 612, two digital power meters 613 and 614, and a computerized control system 615 with a connection to a digital data network 616. One embodiment of this invention utilizes a physical Internet connection (e.g., a telephone, coaxial cable or optical fiber). It will be understood, however, that any connection that permits the transmission of digital information (e.g., wireless communication) can be used in an equivalent manner.

The internal system on-board the RFCV 602, includes a fuel subsystem 617, a power converter 618, a direct hydrogen fueling valve 619, a hydrogen fuel cell power plant 620, an electric drive train and associated controller 621, a power switch 622 and an internal Composite Currency Port 623. The operation of the entire internal system is monitored and controlled by an on-board energy management computer 624, which transmits all relevant vehicular information to the driver via an on-board driver console 625.

During operation, the external and internal systems are connected by the Composite Currency Cable 626, and the data connection 628, 626, 631 is used to determine the desired mode of vehicular operation. (Alternate data connections, such as a separate wireless data link between the RFCV and port controller, are also within the scope of the present invention.) From an operational point of view, there are only two modes of interaction between the external and internal systems: refueling and generation. The distinction between local and networked modes of operation has been illustrated in FIGS. 2 through 5 and is only determined by the nature of the data exchanges associated with the energy transactions.

In the Refueling Mode the internal and external systems exchange water, data and electricity in the following manner:

The computer control system 615 in the external Port Controller 603 maintains the first power switch 610 in position 2 (thereby delivering power to the building). Simultaneously, the second power switch 611 is placed in position 3. The on-board energy management computer 624 enables the power switch 622 and places it in position 3 (thereby delivering power to the vehicle). Under these conditions, water is delivered to the vehicle via the water connection 627, 626, 632 AC power from the electricity grid 606 is delivered via the electricity port connection 629, 626, 630. Electricity is metered by the digital meter 614.

The AC electricity is delivered to the AC/DC & DC/AC power converter 618, and subsequently converted into DC electricity that can be used by the Fuel Subsystem 617. This process continues until the desired refueling level has been reached.

The Fuel Subsystem 617 includes three components: a water purification system 633, an electrolytic fuel production system 634, and a hydrogen storage system 635. In one embodiment of the present invention, the hydrogen produced by the electrolytic fuel production system 634 is compressed electrolytically to a pre-established operating pressure (e.g., 2000 psi) and kept in appropriate pressure vessels. Other storage methods, such as those employing metal hydride compounds or carbon-based materials, are also suitable for use in this invention.

After the refueling process has been completed, the connection between the external and internal systems is broken, and a record of the appropriate transactions is generated as illustrated in FIG. 2.

After refueling, the RFCV regulates the hydrogen on-board to an appropriate operating pressure, and delivers it to the hydrogen fuel cell power plant 620. The power generated by the hydrogen fuel cell power plant 620 is then directed to the electric motor drive train 621, which provides the motive power to propel the vehicle.

In the foregoing discussion, the hydrogen fuel cell power plant 620 and the electrolyzer 634 have been treated as separate, discrete elements within the vehicle's internal system. It is understood, however, that these two components can be combined into a single, reversible integrated regenerative fuel cell unit.

In the Power Generation Mode the internal and external systems exchange data and electricity in the following manner:

The computer control system 615 in the Port Controller 603 maintains the first power switch 610 in position 2 (to maintain an uninterrupted supply of power to the building). Simultaneously, the second power switch 611 is placed in the power generation position 1. Under these conditions, DC power from the hydrogen fuel cell power plant 620 is delivered to the AC/DC & DC/AC power converter 618, and subsequently converted into AC electricity. This electricity is delivered to the building's main electrical panel 607 and metered by a digital power meter 614. In one embodiment of this invention, this process continues until the power generated by the vehicle is sufficient to satisfy the power demand from the building. The time required to achieve this will depend on the prevailing loads and size of the vehicular power plant. Once the power generated by the vehicle is sufficient to satisfy the building's demand, the on-board energy management computer 624, enables the power switch 610 and places it in the power generation position 1, thereby disengaging the building from the electricity grid.

The external systems 601 may optionally also include a metering valve 650 on the supply line from the water source 609. The metering valve 650 is controlled by the external controller's computer 615.

It should be understood that the communication and control functions of the Port Controller might not be required in certain environments and circumstances. For example, individual vehicle owners or operators may choose to transfer power to stand-alone appliances or to buildings in remote locations that are disconnected from electricity or information networks. Under these conditions, the power generated from the vehicle could be treated in a manner similar to that applied to generator sets or battery packs.

It should be noted that the direct hydrogen-refueling valve 619 enables the vehicle to refuel from conventional (e.g., compressed hydrogen sources).

In the preferred embodiment described herein, the external port controller communicates and operates in conjunction with an onboard energy management computer 624, which serves as an internal controller for the RFCV. However, in a less preferred embodiment also within the scope of the present invention, instead of the energy management computer 624, the RFCV may include a less sophisticated internal controller or no internal controller at all, in which case the external port controller controls all aspects of the refueling and/or delivery transactions.

### g. Hydrogen Production & Storage System Schematics

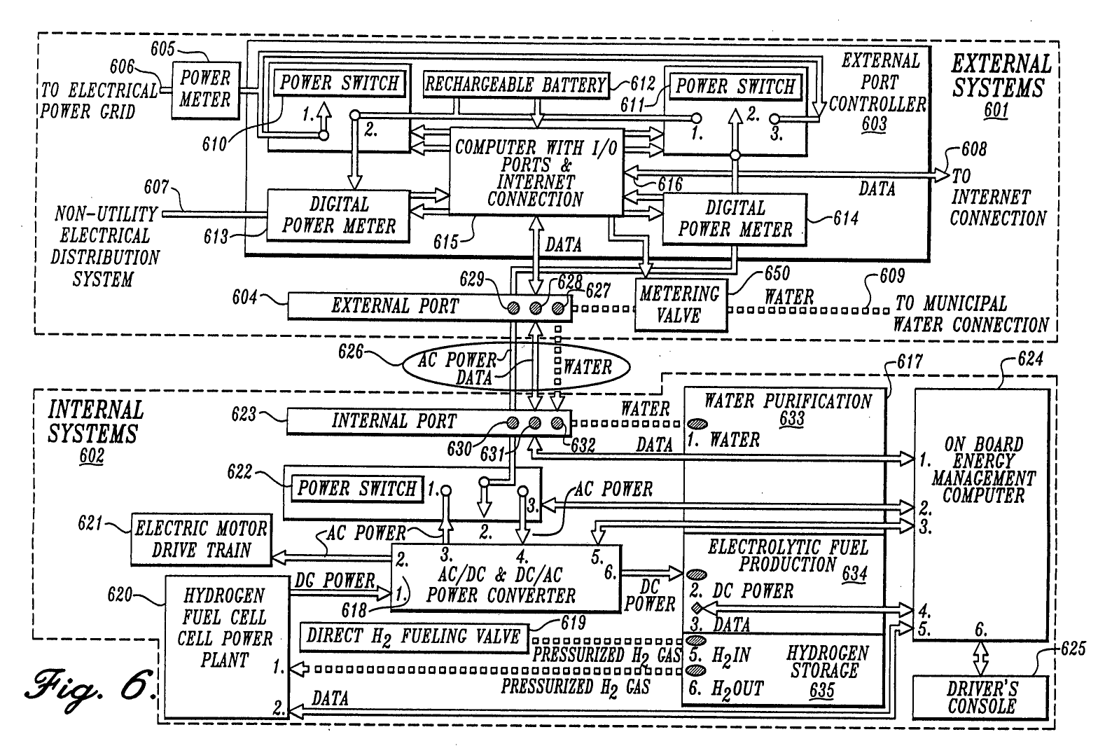

FIG. 7 illustrates schematically the main components of a suitable fuel subsystem 617 on-board the RFCV. It includes a water purification system 701, an electrolytic fuel production system 702 and a hydrogen storage system 703. During refueling, DC power is delivered to the electrolytic fuel production system 702 and water is deposited in a reservoir 704. This water is subsequently passed though a pump 705 which delivers it to the de-ionization bed 706.

Purified water is then delivered to the PEM electrolyzer 707 where it is decomposed into hydrogen and oxygen. In one embodiment of the present invention, the oxygen gas is vented through a port 708. The hydrogen stream is electrolytically compressed by the electrolytic fuel production system 702, which raises the pressure to the desired levels (e.g., 2000 PSI or higher). The compressed hydrogen stream is then delivered to the hydrogen storage system 703. A one-way valve 710 directs the flow to the storage containers 711. One embodiment of the present invention uses pressure vessels but other means of storage can also be implemented (e.g., metal hydride and carbon-based media).

For refueling via externally supplied compressed hydrogen, the one-way valve 710 is rotated by a quarter of a turn in the clockwise direction, thereby connecting the incoming hydrogen stream 712 to the storage subsystem 710 and, simultaneously, preventing the incoming high-pressure stream 712 from reaching the electrolytic fuel production system 702. This feature increases the overall safety of the system by eliminating the possibility of high-pressure gases flowing back into the PEM electrolyzer 707. In addition, a relief valve 713 is always set to a maximum pressure threshold level. In the event of accidental over-pressurization (e.g., collision-related fire) excess gas will be vented in a non-catastrophic manner. Most modern pressure vessels incorporate a pressure-relief mechanism in their construction. Examples of such mechanisms include burst discs 717 that will tolerate a prescribed pressure differential before rupturing in a well-defined and predictable manner. Once ruptured, these discs allow excess gas to be expelled in a non-catastrophic manner.

Once the storage system has been filled to capacity, the one-way valve 710 is automatically turned by another quarter of a turn in the clockwise direction. This configuration seals the hydrogen storage system and both hydrogen streams. In addition, the PEM electrolyzer 707 and the re-circulating pump 705 can be disengaged.

A pressure regulator 714 regulates the pressure from the hydrogen storage system and delivers it to the hydrogen fuel power plant a lower pressure and via the hydrogen out port 716 (e.g., from 2400 PSI to 30 PSI, which is a typical operating pressure range in FCVs using hydrogen and air).

In yet another embodiment of the present invention, the oxygen stream 708 is not vented to the atmosphere but stored for later delivery to the hydrogen fuel cell power plant 620 for the purpose of increasing overall system efficiency (by virtue of the higher concentration of oxygen in the oxidant stream).

The entire operation of the hydrogen production and storage system is controlled by an internal on-board computer 715. This computer can use traditional Programmable Logic Control (PLC) algorithms, or be based on more modern Digital Signal Processing (DSP) schemes. In any event, this computer will operate subject to the instructions of the vehicle's On Board Energy Management Computer 624. The relevant instructions and data exchange will occur through the data connection 718. As an added safety measure, a battery or other electrical device may be provided for power backup. Finally, all mechanical and pneumatic systems are preferably designed to have a “fail-safe” feature (i.e., to default to a safe configuration when power is interrupted).

### h. Composite Currency Connection System

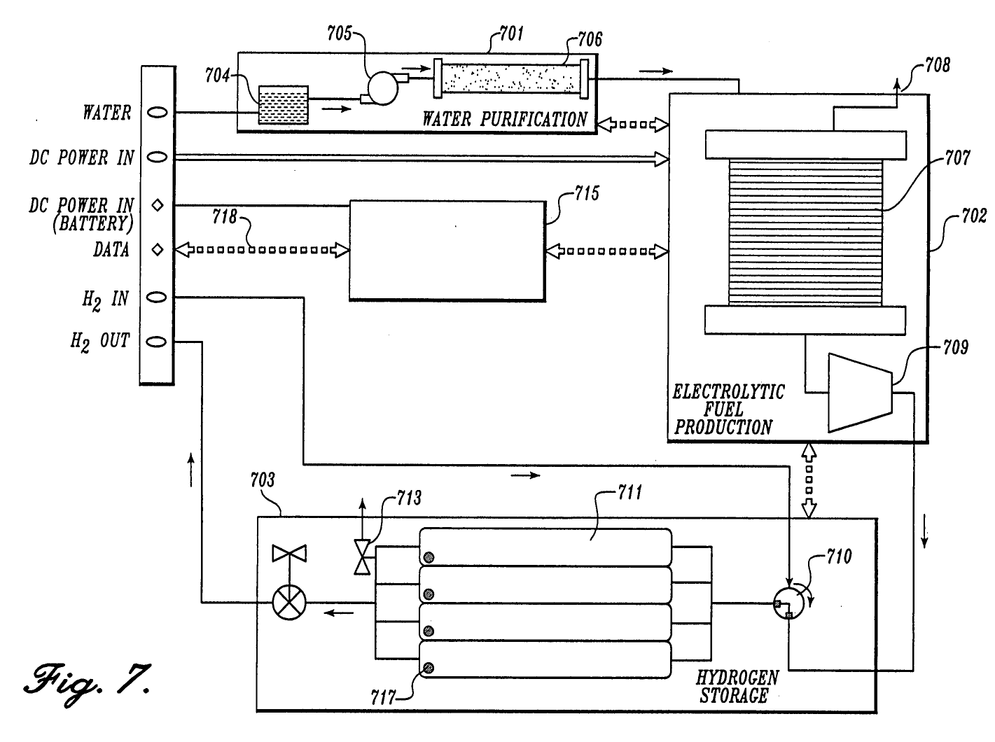

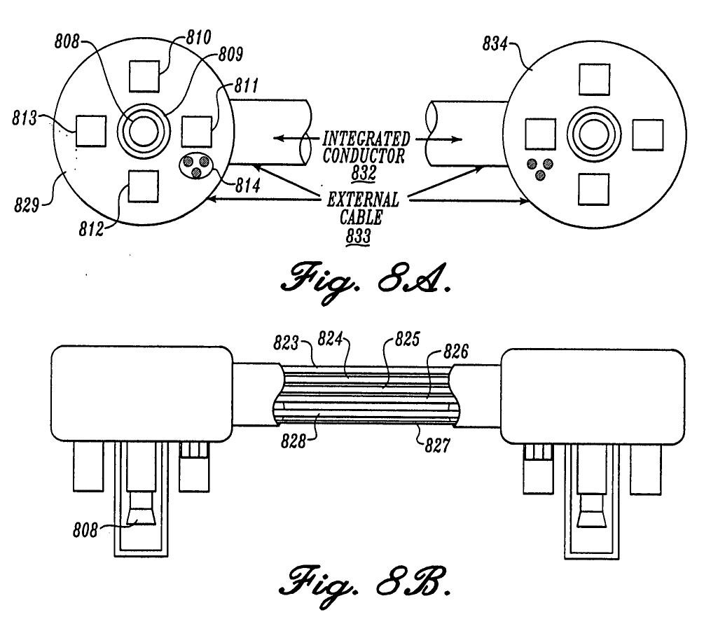

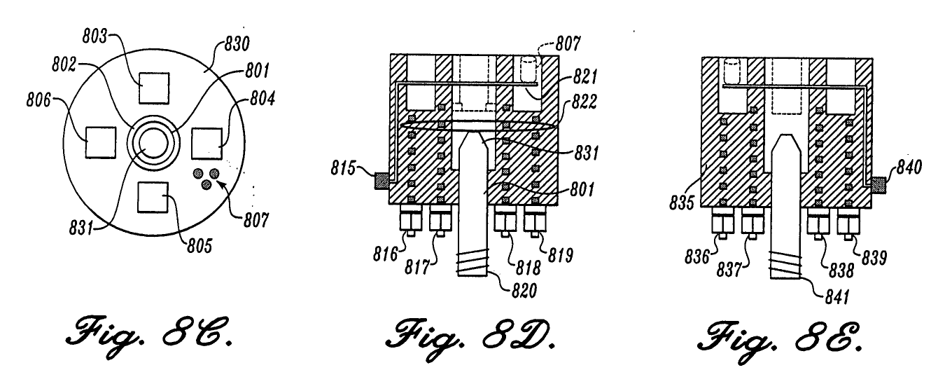

The external Composite Currency Port 830 functions as a receptacle for a Composite Currency Plug 829. Two Composite Currency Plugs 829 and 834, permanently attached to each end of the Composite Currency Integrated Conductor 832, form the Composite Currency Cable 833 (FIGS. 8A and 8B). One end of the Composite Currency Cable 833 plugs into the external Composite Currency Port 830 (FIGS. 8C and 8D), while the other end plugs into the RFCV's Composite Currency Port 835 (FIG. 8E), thereby connecting the vehicle to the external Composite Currency Port 830. The Composite Currency Cable 833 and its two corresponding Composite Currency Ports 830 and 835, together, comprise the Composite Currency Connection System while a manually engageable connector cable is illustrated, an automated docking and connection may be utilized in the present invention.

For automotive applications, the Composite Currency Connection System are preferably capable of delivering up to 75 kilowatts of electrical power and 20 liters of water per hour. For heavy-duty vehicle applications, such as trucks and busses, the system is preferably capable of delivering up to 250 kilowatts of power and 100 liters of water per hour. Power delivery of 250 kilowatts requires three separate electrical pathways, plus a ground, for a total of four conductors. A suitable four-conductor system is depicted in FIGS. 8A through 8E.

FIGS. 8A to 8E are not drawn to scale, but merely provide a schematic representation of the Composite Currency Connection System.

The Composite Currency Integrated Conductor 832 contains multiple flexible heavy-duty AC conductor cables 823 to 826 for the conduction of one or multiple phases of AC power, a shielded conductor cable 827 for the transmission of data, and a flexible hose 828 to carry water. A single integrated cable providing electricity, water and data connections is preferred, but it should be understood that two or three separate connections including a wireless data connection may alternately be employed.

The Composite Currency plug contains four heavy-duty metal prongs 810 to 813 for connection to three phase AC current, three small pins 814 for connection to data, and a single bayonet connector 808, encircled by a waterproof sleeve 809, for connection to water. The prongs 810 to 813 plug into the Composite Currency Port's corresponding power receptacles 803 to 806, and the pins 814 plug into the port's corresponding data receptacle 807.

The bayonet connector 808 plugs into the neck 831 of the Composite Currency Port's pressure valve connection assembly 801. Connection pressure between the bayonet connector 808 and the pressure valve's neck 831 causes the valve to open, allowing the flow of water. The sleeve 809 fits snugly into the sleeve well 802, forming a moisture barrier between the valve connection point and the adjacent AC power prongs 810 to 813 and AC power receptacles 803 to 806.

The Composite Currency Port's internal AC power conductors 822 connect the AC power receptacles 803 to 806 to the surface mounted three-phase AC power connection lugs 816 to 819: The internal data conductor 821 connects the data receptacle 807 to the surface mounted data port 815. The pressure valve extends through the base of the Composite Currency Port to the surface mounted water connection 820.

The exterior Composite Currency Port 830 connects to the Composite Currency Port Controller via the AC power connection lugs 816 to 819 and the data port 815, and to municipal water via the water connection 820.

The Vehicle's Composite Currency Port 835 connects to the vehicle's power converter via the AC power connection lugs 836 to 839, the vehicle's on board energy management computer via the data port 840, and the vehicle's hydrogen production and storage system via the water connection 841.

While the preferred embodiment of the invention has been illustrated and described, it will be appreciated that various changes can be made therein without departing from the spirit and scope of the invention.

1-58 (Cancelled)

59. A method for distributing energy to a fuel cell powered device coupled to a port, the port being coupleable to at least one energy supply source and capable of communicating with the device, the method comprising:
communicating an energy transfer request from one of the device to the port or the port to the device; and
transferring energy to the device in response to the request.

60. The method of claim 59, wherein transferring energy to the device further comprises delivering the energy according to one or more of a predetermined price, delivery time and generation source.

61. The method of claim 59, wherein transferring energy to the device further comprises notifying the port that the device is ready to receive the energy transfer.

62. The method of claim 59, wherein transferring energy to the device further comprises transferring water or constituents of water to the device.

63. The method of claim 59, wherein transferring energy to the device further comprises measuring the amount of energy transferred to the device from the port.

64. The method of claim 63, wherein measuring the amount of energy transferred to the device further comprises interrupting the energy transfer when a predetermined amount of energy has been transferred.

65. The method of claim 59, wherein the port is further capable of communicating data associated with a first energy service provider having the device as a customer, and communicating data associated with a second energy service provider having the port as a customer, and further wherein communicating an energy transfer request from the device to the port comprises:
establishing a first logical communications link for data exchange pertaining to the first energy service provider;
communicating the energy transfer request to the first energy service provider over the first logical communications link; and
processing the energy transfer request to create an energy purchase request according to energy transfer preferences associated with the device.

66. The method of claim 65, wherein processing the energy transfer request further comprises:
specifying a preferred energy supply source to provide energy to the port;
identifying one or both of a preferred time and availability to begin transferring energy from the port to the device; and
stating a preferred price for the energy to be transferred.

67. The method of claim 65, further comprising:
establishing a second logical communications link for data pertaining to the second energy service provider;
communicating the energy purchase request from the first energy service provider to the second energy service provider over the first and second logical communications links;
processing the energy purchase request according to energy transfer criteria associated with one or both of the port or device to obtain a energy purchase reply;
communicating the energy purchase reply to the first energy service provider over the first and second logical communications links;
receiving a response from the first energy service provider over the first and second logical communications links indicating acceptance of the purchase reply; and
transferring an energy purchase order from the first energy service provider to the second energy service provider over the first and second logical communications links in response to the accepted reply.

68. The method of claim 67, wherein processing the energy purchase request further comprises:
comparing the energy purchase request with the energy transfer criteria; and
calculating a purchase price based upon the energy transfer criteria.

69. The method of claim 67, further comprising negotiating the energy purchase request.

70. The method of claim 69, wherein negotiating the energy purchase request further comprises:
modifying one or more of a purchase price, a time for delivery of the energy, and the amount of energy to be delivered in response to the reply;
compiling a modified energy purchase request; and
sending the modified request to the second energy service provider.

71. The method of claim 67, further comprising:
informing the port through the second logical communications link of the amount of energy to be transferred and the time of the energy transfer.

72. The method of claim 67, further comprising:
compiling an invoice for the energy transfer; and
submitting the invoice to an account associated with one or both of the device and port.

73. A method for distributing energy from a fuel cell powered device coupled to a port, the port being coupled to an energy consumer and capable of communicating with the device, the method comprising:
communicating a generation request from one of the port to the device or device to the port;
generating energy within the device in response to the generation request; and
supplying the generated energy through the port to the energy consumer.

74. The method of claim 73, wherein supplying the generated energy further comprises supplying the energy to an electrical distribution system.

75. The method of claim 73, wherein supplying the generated energy further comprises supplying the energy to a local electrical distribution system.

76. The method of claim 73, wherein the generation request further comprises generating the energy according to a predetermined price and delivery time.

77. The method of claim 73, wherein supplying the generated energy further comprises notifying the port that the device is ready to begin supplying energy.

78. The method of claim 73, wherein supplying the generated energy further comprises measuring the amount of energy transferred from the device.

79. The method of claim 78, wherein measuring the amount of energy transferred from the device further comprises interrupting the energy transfer when a predetermined amount of energy has been transferred.

80. The method of claim 78, further comprising:
determining a maximum energy generation threshold value for the device; and
interrupting a transfer of the generated energy to the consumer when the energy supplied reaches the threshold value.

81. The method of claim 73, wherein the port is further capable of communicating data pertaining to a first energy service provider having the device as a customer, and communicating data pertaining to a second energy service provider having the port as a customer, and further wherein generating energy within the device comprises:
estimating the total amount of energy stored by the device;
establishing a first logical communications link for data pertaining to the first energy service provider;
communicating the amount over the first logical communications link; and
processing the energy amount to create an energy sales offer according to sales preferences associated with the device.

82. The method of claim 81, wherein processing the energy amount further comprises stating a preferred price for the estimated amount of energy.

83. The method of claim 81, further comprising:
establishing a second logical communications link for data pertaining to the second energy service provider;
communicating the energy sales offer from the first energy service provider to the second energy service provider over the first and second logical communications links;
comparing the energy sales offer to energy purchase criteria associated with one or both of the port or device;
determining if the sales offer and the energy purchase criteria match;
compiling a purchase order that includes an energy price; and
communicating the purchase order to the first energy service provider over the first and second logical communications links.

84. The method of claim 83, wherein determining if the sales offer and the energy purchase criteria match further comprises:
comparing an energy cost presented by the second energy service provider with the purchase order;
determining if the energy cost exceeds the energy price by a predetermined threshold amount; and
accepting the purchase order if the energy cost exceeds the energy price threshold amount.

85. The method of claim 81, further comprising:
compiling an invoice for the energy supplied;
communicating the invoice from the first energy service provider to the second energy service provider along the first and second logical communications links; and
submitting the invoice to an account associated with one or both of the port or device.

86. A method of transferring energy to and from a port adapted to be coupled to a fuel cell powered device, comprising:
receiving an energy transfer request and transferring energy in response to the energy transfer request while operating in a first mode; and
communicating an energy generation request and transferring energy in response to the energy generation request while operating in a second mode.

87. The method of claim 86, further comprising measuring the amount of energy transferred.

88. The method of claim 86, wherein measuring the amount of energy transferred further comprises interrupting the transfer of energy when a predetermined amount of energy has been transferred.

89. The method of claim 86, wherein transferring energy while operating in the first mode further comprises transferring water to the device.

90. The method of claim 86, wherein transferring energy while operating in the first mode further comprises delivering energy according to on or more of a predetermined price, delivery time and generation source and availability.

91. The method of claim 86, wherein transferring energy while operating in the second mode further comprises transferring the energy to an electrical distribution system.

92. The method of claim 86, wherein transferring energy while operating in the second mode further comprises transferring the energy to a local electrical distribution system.

93. A method of transferring energy to and from a fuel cell powered device adapted to be coupled to a port, comprising:
submitting an energy transfer request and receiving energy in response to the energy transfer request while operating in a first mode; and
communicating an energy generation request, generating the energy and transferring the energy in response to the energy generation request while operating in a second mode.

94. The method of claim 93, further comprising measuring the amount of energy transferred.

95. The method of claim 93, wherein measuring the amount of energy transferred further comprises interrupting the transfer of energy when a predetermined amount of energy has been transferred.

96. The method of claim 93, wherein transferring energy while operating in the first mode further comprises transferring water to the device.

97. The method of claim 93, wherein transferring energy while operating in the first mode further comprises delivering energy according to one or more of a predetermined price, delivery time, generation source and availability.

98. The method of claim 93, wherein transferring energy while operating in the second mode further comprises transferring the energy to an electrical distribution system.

99. The method of claim 93, wherein transferring energy while operating in the second mode further comprises transferring the energy to a local electrical distribution system.
